(19) United States
(12) Patent Application Publication
(10) Pub. No.: US 2002/0077888 A1
(43) Pub. Date: Jun. 20, 2002

(54) Interview method through network questionnairing

(75) Inventor: Tzu-Pang Chiang, Taoyuan City (TW)

Correspondence Address: DOUGHERTY & TROXELL, SUITE 1404, 5205 LEESBURG PIKE, FALLS CHURCH, VA, 22041, US

(73) Assignee: Acer Communications & Multimedia Inc.

(21) Appl. No.: 09/956,106

(22) Filed: Sep. 20, 2001

(30) Foreign Application Priority Data
Dec. 20, 2000 (TW) 89127295

(51) Int. Cl. G06F 17/60

(52) U.S. Cl. 705/12

(57) ABSTRACT

An interview method through network questionnairing includes steps of: (a) a user inputting an interview request at a user end and then sending it out; (b) a server end receiving the interview request, generating thereby a first questionnaire, and then sending it out; (c) the user end receiving the first questionnaire and then answering the first questionnaire by articulating for recording an interview reply data while the user starting the first questionnaire; (d) the user sending out the interview reply data while the user completing the interview reply data; (e) the server end receiving the interview reply data as an articulation data recording replies of the user during answering the first questionnaire and then storing thereto the interview reply data; and (f) the server end utilizing an articulation recognizing procedure to transform the interview reply data into a written data to be stored therein for further reviewing.

### BACKGROUND OF THE INVENTION

(1) Field of the Invention

The invention relates to an interview method through network questionnairing within a predetermined time duration, and more particularly to the method that utilizes video devices to capture articulation and image data of an interviewee and then the articulation and image data can be further transformed into a written data.

(2) Description of the Prior Art

In the practice of a human resource/match-maker website or office in the art for broking jobs and marriages, a fixed content written questionnaire is usually used to record personal information of an interviewee, and sometimes video taping is also applied. In the written questionnaire, the personal information usually includes educations, experiences, brief autobiography, expected salary, height, weight, age, gender and so on. Such routine questions provided by the written questionnaire can only give the interviewer (an employer, a match-maker, an immigration officer or so) a general understanding upon the interviewee (an job-finder, a marriage-luster, a prospective immigrant or so). In particular, the interviewee usually recites some specific answers for frequently-asked questions on the written questionnaire so as to gain positive evaluation. However, upon such an interview, real attitude and response of the interviewee can not be reflected faithfully. Therefore, the interviewer usually needs to arrange a second interview with the interviewee face to face for questioning some special topics that the interviewer is eager to know. Generally, in the second interview, real-time responses of the interviewee toward the special questions can be obtained and thereby the interviewer can have a better understanding upon the interviewee. In order not to jump to a distorted judgment upon an interviewee, the interviewer usually has to spend more time to arrange further face-to-face interview with most of the interviewee whom have filled up the questionnaire. Apparently, tremendous time of the interviewer will be spent inevitably over the interviewing.

Hence, the written questionnaire in the art can no longer meet the requirements of most interviewers. Yet, it cannot reflect faithfully the real-time reaction of the interviewee, either.

### SUMMARY OF THE INVENTION

Accordingly, it is a primary object of the present invention to provide an interview method through network questionnairing for replacing the conventional written questionnaire described above. Advantages upon using the present invention include: (1) convenience and swiftness provided by adopting the articulation and image reply so that no term-by-term writing answer is required for the interviewee; (2) understanding about the witness of the interviewee provided by adopting the answering within a predetermined time duration so that real-time reaction of the interviewee can be obtained; and (3) repeatability and readability of the interview record provided to the interviewer by transforming the articulation and image data of the interviewee into a written data.

The interview method through network questionnairing in accordance with the present invention includes steps of: (1) a user inputting an interview request at a user end; (2) the interview request being forwarded from the user end to a server end; (3) a first questionnaire in accordance with the interview request being forwarded from the server end to the user end; (4) the user answering the first questionnaire by articulating for recording an interview reply data while the user starting the first questionnaire at the user end; (5) the interview reply data being forwarded to the server for recording the answering of the user in a articulation data form; and (6) utilizing an articulation recognizing procedure to transform the interview reply data into a written data to be stored in the server end for further reviewing by the interviewer.

All these objects are achieved by the interview method through network questionnairing described below.

### BRIEF DESCRIPTION OF THE DRAWINGS

The present invention will now be specified with reference to its preferred embodiment illustrated in the drawings, in which

FIG. 1 is a flowchart of a first embodiment of the interview method through network questionnairing in accordance with the present invention; and

FIG. 2 is a flowchart of a second embodiment of the interview method through network questionnairing in accordance with the present invention.

### DESCRIPTION OF THE PREFERRED EMBODIMENT

The invention disclosed herein is directed to an interview method through network questionnairing. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

First Embodiment

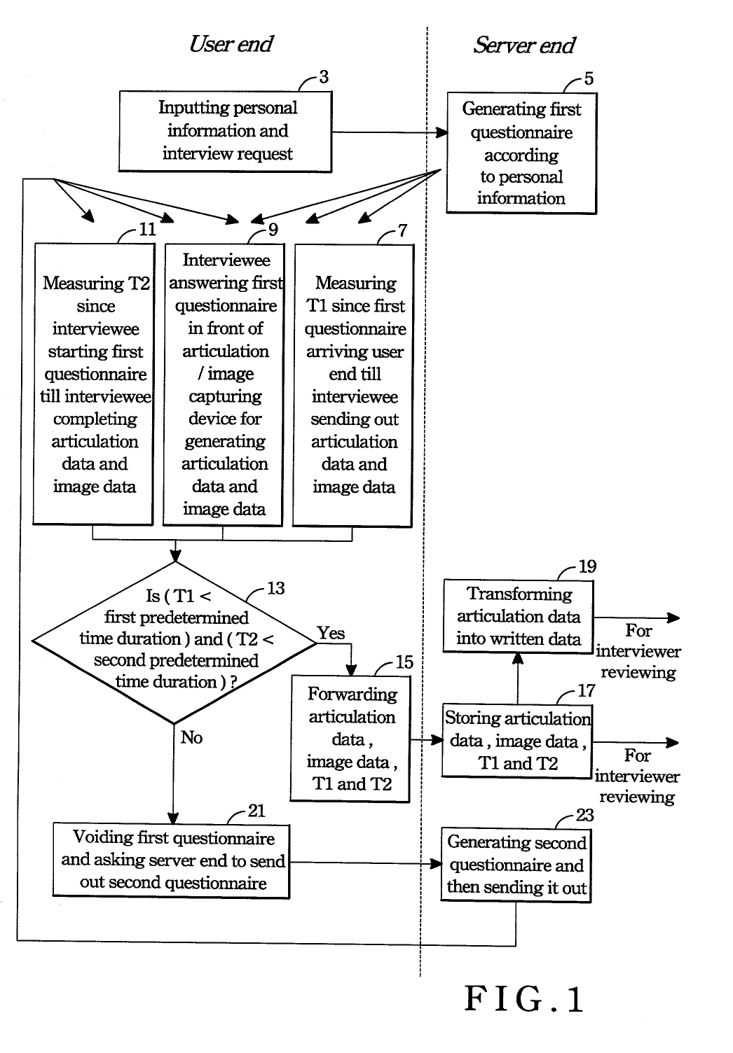

Referring now to FIG. 1, a flowchart is provided to show a first embodiment in accordance with the present invention. The interview method through network questionnairing of the present invention includes following steps.

Step 3: A user at a user end inputs his/her personal information and an interview request. Then, the personal information and the interview request are sent out of the user end.

Step 5: A control program disposed at the server end receives the personal information and the interview request from the user end. The control program of the server end can generate a first questionnaire according to the personal information and the interview request. Then, the first questionnaire is sent out of the server end.

Step 7: A first time counting process is started as soon as the first questionnaire arriving the user end, and the first time counting process cannot be stopped until the interviewee (the user) at the user end sends out articulation data and image data in response to the first questionnaire. An interview waiting time duration T1 is generated by the first time counting process.

Step 9: While the interviewee starts accessing the first questionnaire at the user end, the interviewee needs to answer the first questionnaire in front of an articulation/image capturing device so that the articulation data and the image data (together as an interview reply data) can be generated.

Step 11: An interview replying time duration T2 is measured since the first questionnaire is accessed by the user (thus, the second time counting process is triggered) till the interviewee completes the articulation data and the image data of the interviewing (i.e., the second time counting process is stopped).

Step 13: It is to be determined whether or not the T1 is smaller than a first predetermined time duration and whether or not the T2 is smaller than a second predetermined time duration. That is to determine: (1) if the user at the user end has sent out the articulation data and the image data of the interviewing within the first predetermined time duration; and (2) if the user can answer the questionnaire, i.e., complete the preparation of articulation data and the image data of the interviewing within the second predetermined time duration.

Step 15: If the determination in step 13 is positive, then the articulation data, the image data, the interview waiting time duration TI and the interview replying time duration T2 are sent out of the user end.

Step 17: The articulation data, the image data, the interview waiting time duration T1 and the interview replying time duration T2 are received at the server end. Then, the articulation data, the image data, the interview waiting time duration T1 and the interview replying time duration T2 are stored in the server end, and allowed to be accessed by the interviewer later.

Step 19: After an articulation recognizing procedure performed at the server end, the articulation data of the interviewing can be transformed into a written data to be stored in the server end. In the present invention, such written records (the written data) representing the interviewee's response to the first questionnaire are stored at the server end and ready to be accessed by the interviewer.

Step 21: If the determination in step 13 is negative, user's response to the first questionnaire is abandoned and the control program located at the server end is informed to send out a second questionnaire.

Step 23: The server end voids the first questionnaire and sends out the second questionnaire to the user end, for the user to repeat aforesaid step 7 to step 13.

Second Embodiment

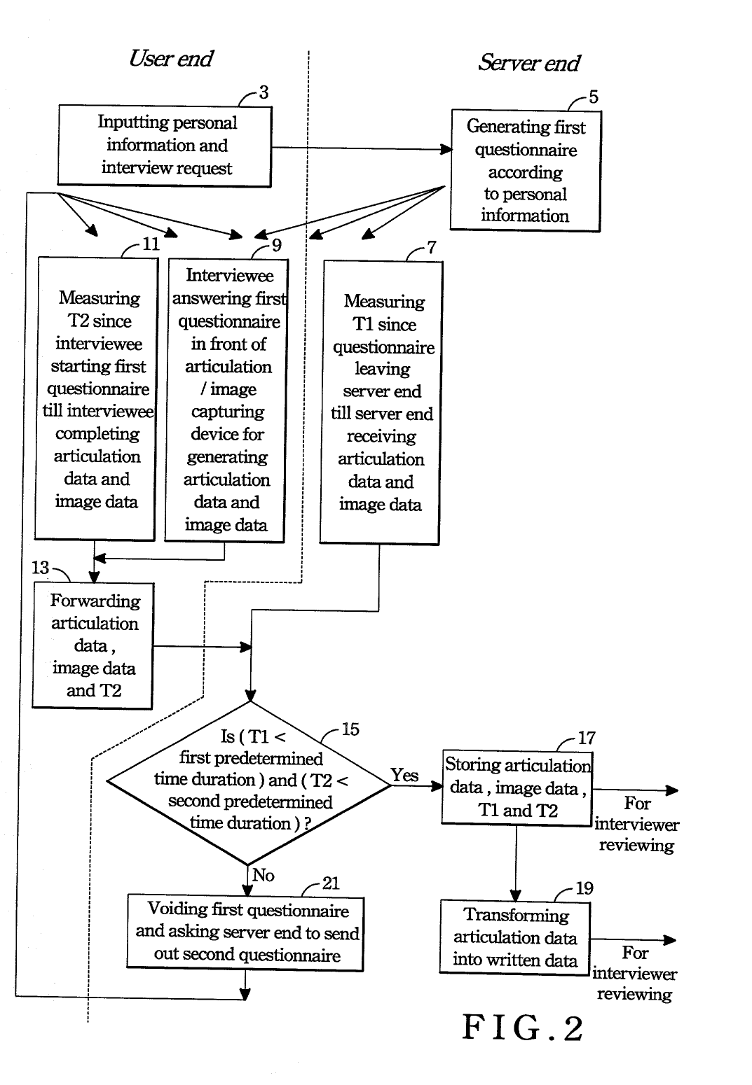

Referring now to FIG. 2, a flowchart of a second embodiment in accordance with the present invention is present. The interview method through network questionnairing of the present invention includes following steps.

Step 3: A user at a user end inputs his/her personal information and an interview request. Then, the personal information and the interview request are sent out of the user end.

Step 5: A control program located at the server end receives the personal information and the interview request from the user end. The control program of the server end can generate a first questionnaire according to the personal information and the interview request. Then, the first questionnaire is sent out of the server end.

Step 7: A first time counting process is started as soon as the first questionnaire leaving the server end, and the time counting cannot be stopped until the user's articulation data and image data in response to the first questionnaire is received at the server end. Thus, an interview waiting time duration T1 is generated by the first time counting process.

Step 9: While the interviewee starts accessing the first questionnaire at the user end, the interviewee needs to answer the first questionnaire in front of an articulation/image capturing device so that the articulation data and the image data (together as an interview reply data) can be generated.

Step 11: An interview replying time duration T2 is measured since the first questionnaire is accessed by the user (thus, the second time counting process is triggered) till the interviewee completes the articulation data and the image data of the interviewing (i.e., the second time counting process is stopped).

Step 13: The articulation data, the image data and the T2 are sent out of the user end.

Step 15: The articulation data, the image data and the T2 are received at the server end. It is to be determined whether or not the T1 is smaller than a first predetermined time duration and whether or not the T2 is smaller than a second predetermined time duration. That is to determine: (1) if the user at the user end can make possible the articulation data and the image data of the interviewing to arrive the server end within the first predetermined time duration; and (2) if the user can answer the questionnaire, i.e., complete the preparation of articulation data and the image data of the interviewing within the second predetermined time duration.

Step 17: If the determination in step 15 is positive, then the articulation data, the image data, the T1 and the T2 are stored in the server end, and allowed to be accessed by the interviewer later.

Step 19: After an articulation recognizing procedure performed at the server end, the articulation data of the interviewing can be transformed into a written data to be stored in the server end. In the present invention, such written records (the written data) representing the interviewee's response toward the first questionnaire are stored at the server end and ready to be accessed by the interviewer.

Step 21: If the determination in step 15 is negative, the control program located at the server end then voids the first questionnaire. Thereafter, the control program will generate a second questionnaire and then forward the second questionnaire to the user end for the interviewee to repeat aforesaid step 7 to step 13.

In both embodiments of the present invention described above, contents of the first questionnaire generated in step 5 can be a fixed content or a adjustable content in response to the personal information of the interviewee. For instance, to a graduate without any prior job experience, the first questionnaire can include a question of inquiring his/her expectation upon the first job. For another example, to an interviewee who has job experience, but just leaves his/her previous position, the first questionnaire can include a question of inquiring the reason why he/she has left his/her previous job.

In both embodiments of the present invention described above, capturing of the articulation data and the image data in step 9 can be fulfilled only if the user end is equipped with a recording facility (i.e., an articulation capturing device) for capturing the articulation of the interviewee or further with a taping facility (i.e., an image capturing device) for capturing the image of the interviewee. In the present invention, the user end can be: (a) a personal computer equipped with a voice-imitating card and a microphone (the articulation capturing device), further having a CCD camera, in which the personal computer can provide a built-in hard disk for allowing the user to temporarily store the articulation and image data therein; and (b) a telephone equipped with an image capturing device (a 3G mobile phone for example) or a display telephone, in which the user can store the articulation and image data directly into the server end for waiving the telephone from the cost of a built-in hard disk.

By providing the present invention, the interview method through network questionnairing in a limited time can allow the interviewee to answer some specific questions in a network questionnaire that the interviewer is particularly eager to know. Also, during the questionnairing, the real-time response of the interviewee can be easily observed while the interviewee answering the questionnaire in a limited time. Hence, the interviewee can have no chance to recite some specific answers before the interviewing, and thus a better understanding upon the interviewee can be obtained.

While the present invention has been particularly shown and described with reference to a preferred embodiment, it will be understood by those skilled in the art that various changes in form and detail may be without departing from the spirit and scope of the present invention.

I claim:

1. An interview method through network questionnairing, comprising steps of:
(a) a user inputting an interview request at a user end and then sending out the interview request from the user end;
(b) a control program disposed at a server end receiving the interview request, generating thereby a first questionnaire, and sending out therefrom the first questionnaire;
(c) the user receiving the first questionnaire, and answering the first questionnaire by articulating for recording an interview reply data;
(d) the user sending out the interview reply data from the user end while the user completing the interview reply data; and
(e) the control program receiving the interview reply data, and then storing the interview reply data at server end;
wherein the interview reply data is an articulation data recording replies in response to the first questionnaire.

2. The interview method through network questionnairing according to claim 1, wherein said interview request of said step (a) further comprises a personal information of said user and wherein said first questionnaire of said step (b) is generated in accordance with the personal information.

3. The interview method through network questionnairing according to claim 1 further comprises a time counting process, the time counting process is started in said step (b) while said first questionnaire is sent out of said server end, and is stopped in said step (e) while said interview reply data is received at said server end, in which an interview waiting time duration is generated by the time counting process, and in which said server end voids said first questionnaire while the interview waiting time duration is longer than a first predetermined time duration.

4. The interview method through network questionnairing according to claim 1 further comprises a time counting process, the time counting process is started in said step (c) while said first questionnaire is received at said user end, and is stopped in said step (d) while said interview reply data is sent out of said user end, in which an interview waiting time duration is generated by the time counting process, and the interview waiting time duration together with said interview reply data are sent to said server end.

5. The interview method through network questionnairing according to claim 4, wherein said server end of said step (e) voids said first questionnaire while said interview waiting time duration received from said user end is longer than a first predetermined time duration.

6. The interview method through network questionnairing according to claim 1 further comprises a time counting process, the time counting process is started in said step (c) while said user starting accessing said first questionnaire and is stopped in said step (d) while said user completing said interview reply data, in which an interview replying time duration is generated by the time counting process, and the interview replying time duration together with said interview reply data are sent to said server end.

7. The interview method through network questionnairing according to claim 6, wherein said server end of said step (e) voids said first questionnaire while said interview replying time duration received from said user end is longer than a second predetermined time duration.

8. The interview method through network questionnairing according to claim 1, wherein in said step (c) said user further records an image data while answering said first questionnaire, and thereby wherein said interview reply data includes said articulation data and the image data.

9. The interview method through network questionnairing according to claim 1, wherein in said step (e) an articulation recognizing procedure is performed at the server end to transform said articulation data of said interview reply data into a written data to be stored therein.

10. The interview method through network questionnairing according to claim 1, wherein said server end is a personal computer equipped with an articulation and image capturing device.

11. The interview method through network questionnairing according to claim 1, wherein said user end is a telephone equipped with an image capturing device.

12. An interview method by a network questionnaire generated at a server end, comprising steps of:
(a) receiving an interview request generated by a user at a user end;
(b) generating a first questionnaire in response to the interview request;
(c) forwarding therefrom the first questionnaire to the user end; and
(d) receiving an interview reply data sent from the user end, the interview reply data including an articulation data which records articulation answering of the user upon starting the first questionnaire at the user end.

13. The interview method by a network questionnaire generated at a server end according to claim 12, wherein said interview request of said step (a) further includes personal information of said user and wherein said first questionnaire of said step (b) is generated in accordance with the personal information.

14. The interview method by a network questionnaire generated at a server end according to claim 12 further comprises a time counting process, which is started in said step (c) while said first questionnaire is sent out of said server end and is stopped in said step (d) said interview reply data is received at said server end, an interview waiting time duration is generated by the time counting process, and in which said server end voids said first questionnaire while the interview waiting time duration is longer than a first predetermined time duration.

15. The interview method by a network questionnaire generated at a server end according to claim 12, wherein in step (d) an interview replying time duration is received at the server end, the interview replying time duration counts from a timing of said user starting accessing said first questionnaire to another timing of said user completing said interview reply data, in which said server end voids said first questionnaire while said interview replying time duration is longer than a second predetermined time duration.

16. The interview method by a network questionnaire generated at a server end according to claim 12, wherein said interview reply data of said step (d) further includes an image data which is recorded while said user answering said first questionnaire, and thereby wherein said interview reply data includes both articulation and image of said user.

17. The interview method by a network questionnaire generated at a server end according to claim 12, wherein said server end of said step (d) utilizes an articulation recognizing procedure to transform said articulation data of said interview reply data into a written data to be stored therein, after said server end receiving said interview reply data.

18. The interview method by a network questionnaire generated at a server end according to claim 14, wherein when said interview waiting time duration is longer than said first predetermined time duration, a second questionnaire is sent from said server end to repeat said steps (b) to (d).

19. The interview method by a network questionnaire generated at a server end according to claim 15, wherein when interview replying time duration is longer than said second predetermined time duration, a second questionnaire is sent from said server end to repeat said steps (b) to (d).
